(19) United States
(12) Patent Application Publication
(10) Pub. No.: US 2025/0355301 A1
(43) Pub. Date: Nov. 20, 2025

(54) DISPLAY MODULE

(71) Applicant: AUO Corporation, Hsinchu City (TW)

(72) Inventors: Pei-Wan HSIAO, Hsinchu City (TW); Shang-Wei HSIEH, Hsinchu City (TW); Jia-Hong WANG, Hsinchu City (TW); Yi-Wen LIN, Hsinchu City (TW); Wang-Shuo KAO, Hsinchu City (TW); Ya-Ling HSU, Hsinchu City (TW); Chen-Hsien LIAO, Hsinchu City (TW)

(21) Appl. No.: 18/947,620

(22) Filed: Nov. 14, 2024

(30) Foreign Application Priority Data
May 15, 2024 (TW) 113117981

(51) Int. Cl. G02F 1/1339; G02B 5/30; G02F 1/1335; G02F 1/13357; G02F 1/1362; G02F 1/1368

(52) U.S. Cl. CPC G02F 1/1339; G02F 1/133548; G02F 1/133603; G02F 1/133607; G02F 1/136209; G02F 1/1368; G02B 5/3016; G02F 2203/64

(57) ABSTRACT

A display module which includes a backlight module, a LCD panel and a LED display panel is provided. The backlight module has a light exiting region and a fringe region adjacent to the light exiting region. The LCD panel which is disposed on the backlight module includes a sealant. The LED display panel which is disposed on the fringe region of the backlight module has a surface, while at least a part of the sealant overlaps the LED display panel in the normal direction of this surface. The backlight module includes at least one optical film disposed on the light exiting region, and the optical film is located at one side of the backlight module facing to the LCD panel. The optical film extends from the light exiting region to the fringe region of the backlight module and covers the LED display panel.

### RELATED APPLICATIONS

This application claims priority to Taiwan Application Serial Number 113117981, filed May 15, 2024, which is herein incorporated by reference in its entirety.

### BACKGROUND

### Technical field

The present disclosure relates to a display module. More particular, the present disclosure relates to the display module with liquid crystal display technology.

### Description of Related Art

One of the main methods for producing large format displays (LFDs) is splicing technology. The splicing technology is to splice a plurality of smaller display panels into a large-sized display. In order to meet the demands for large- sized displays, the development of splicing technology has gradually increased. However, the technical challenges faced by splicing technology is that even though the side traces are developed to connect backside chips so as to narrow the frame of the displays, the side traces still occupy a certain space in the displays. As a result, for the requirements of high-resolution displays, the distance between the outermost pixels of the display panel and the edge of the display is larger than the spacing between pixels, thereby causing the discontinuous images on the large-sized displays produced by splicing technology.

### SUMMARY

Accordingly, the disclosure is to provide a display module which is able to improve the continuity of the images on the spliced display.

At least one embodiment of the disclosure provides a display module. The display module includes a backlight module having a light exiting region and a fringe region adjacent to the light exiting region. The display module includes a LCD panel disposed on the backlight module, where the LCD panel includes a sealant. The display module includes a LED display panel disposed on the fringe region of the backlight module, where the LED display panel has a surface, and at least a part of the sealant overlaps the LED display panel in a normal direction of the surface. The backlight module includes at least an optical film disposed on the light exiting region, and the optical film is located at one side of the backlight module facing to the LCD panel. The optical film extends from the light exiting region to the fringe region of the backlight module and covers the LED display panel.

At least one embodiment of the disclosure provides a display module. The display module includes a backlight module having a light exiting region and a fringe region adjacent to the light exiting region. The display module includes a LCD panel disposed on the backlight module, where the LCD panel includes a sealant. The display module includes a LED display panel disposed on the fringe region of the backlight module, where the LED display panel has a surface, and at least a part of the sealant overlaps the LED display panel in a normal direction of the surface. The LED display panel includes a plurality of LED components disposed on the fringe region of the backlight module, wherein the plurality of LED components are arranged in at least two lines along with an extending direction of the sealant. The backlight module includes at least an optical film disposed on the light exiting region, and the optical film is located at one side of the backlight module facing to the LCD panel. The optical film extends from the light exiting region to the fringe region of the backlight module and covers the LED display panel.

According to the aforementioned embodiments, the LED display panel is disposed on the fringe region of the backlight module, so that the LED display panel can emit the light ray toward the sealant. As a result, the light ray emitted by the LED display panel can enter the user's eyes through the sealant of the LCD panel. Therefore, the discontinuity of the images due to the seams decreases, and thereby improving the quality of images.

### BRIEF DESCRIPTION OF THE DRAWINGS

To illustrate more clearly the aforementioned and the other features, merits, and embodiments of the present disclosure, the description of the accompanying figures are as follows:

FIG. 1 illustrates a top view of a display module in accordance with at least one embodiment of the present disclosure;

FIG. 2 illustrates a locally cross-sectional view of a display module in accordance with at least one embodiment of the present disclosure;

FIG. 3 illustrates a locally stereoscopic view of a display module in accordance with at least one embodiment of the present disclosure;

FIG. 4 illustrates a locally stereoscopic view of a display module in accordance with at least another one embodiment of the present disclosure;

FIG. 5 illustrates a locally cross-sectional view of a display module in accordance with at least one embodiment of the present disclosure;

FIG. 6 illustrates a locally cross-sectional view of a display module in accordance with at least another one embodiment of the present disclosure;

FIG. 7 illustrates a locally cross-sectional view of a display module in accordance with at least another one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

Further, when a number or a range of numbers is described with “about,” “approximate,” “substantially,” and the like, the term is intended to encompass numbers that are within a reasonable range considering variations that inherently arise during manufacturing as understood by one of ordinary skill in the art. In addition, the number or range of numbers encompasses a reasonable range including the number described, such as within +/−30%, +/−20%, +/−10% or +/−5% of the number described, based on known manufacturing tolerances associated with manufacturing a feature having a characteristic associated with the number. The words of deviations such as “about,” “approximate,” “substantially,” and the like are chosen in accordance with the optical properties, etching properties, mechanical properties or other properties. The words of deviations used in the optical properties, etching properties, mechanical properties or other properties are not chosen with a single standard.

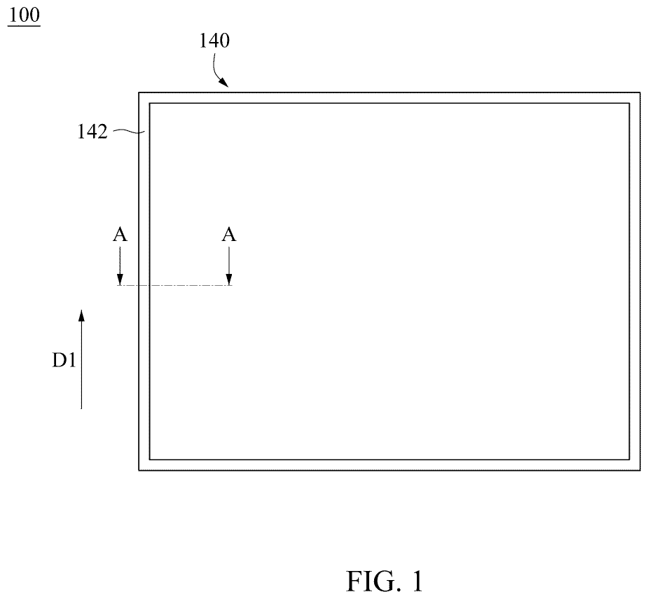

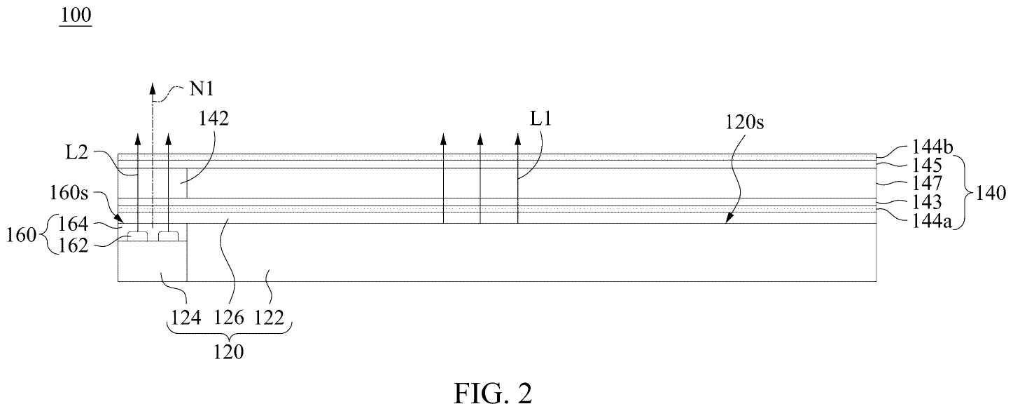

FIG. 1 illustrates a top view of a display module 100 in accordance with one embodiment of the present disclosure, while FIG. 2 illustrates a cross-sectional view taken along a line A-A of the display module 100 in FIG. 1. Referring to FIG. 1 and FIG. 2, the display module 100 includes a backlight module 120, a liquid crystal display (LCD) panel 140 and a light-emitting diode (LED) display panel 160. The backlight module 120 is used to emit the light ray L1 toward the LCD panel 140 and has a light exiting region 122 and a fringe region 124 adjacent to the light exiting region 122.

Specifically, the backlight module 120 may include a light source module (not shown) and a light guide component (not shown). Take the edge-lit backlight module as an example, the light source module of the backlight module 120 may be disposed on the fringe region 124, where the light source module emits the light ray toward the light guide component located at the light exiting region 122. The light ray is led by the light guide plate to leave the backlight module 120 through a light exiting surface 120s. In the embodiment, the fringe region 124 of the backlight module 120 includes the light source module (not shown), and the light source module includes a plurality of light emitting components (not shown) and a circuit substrate (not shown) controlling the light emitting components. Due to the structure of the backlight module 120, the emitting range of the light ray L1 is limited within the surface 120s above the light exiting region 122 instead of extending to the fringe region 124. In other words, the fringe region 124 of the backlight module 120 will not emit the light ray L1 toward the LCD panel 140.

The LCD panel 140 is disposed on the backlight module 120, and the LCD panel 140 includes a sealant 142. Referring to FIG. 1 and FIG.2, the sealant 142 may be distributed around the LCD panel 140 and cover the fringe region 124 of the backlight module 120 in the embodiment. Although the sealant 142 of the LCD panel 140 may overlap the fringe region 124 of the backlight module 120 completely in the embodiment, but the disclosure is not limited to this embodiment. In other embodiments, the sealant 142 may cover a part of the fringe region 124.

The LCD panel 140 may be but not limited to a vertical alignment (VA) LCD panel, an in plane switching (IPS) LCD panel or other LCD panels. In addition, the sealant 142 of the LCD panel 140 may include adhesive materials, such as silicone, acrylic or other similar materials, and the visible light transmittance of the material of the sealant 142 may be between 20% and 95%.

The LED display panel 160 is disposed on the fringe region 124 of the backlight module 120, and the LED display panel 160 has a surface 160s. It is worth mentioning that at least a part of the sealant 142 overlaps the LED display panel 160 in a normal direction N1 of the surface 160s. Specifically, the LED display panel 160 is used to emit a light ray L2 toward the LCD panel 140. Since the sealant 142 overlaps the LED display panel 160 in the normal direction N1, the light ray L2 passes through the sealant 142 of the LCD panel 140.

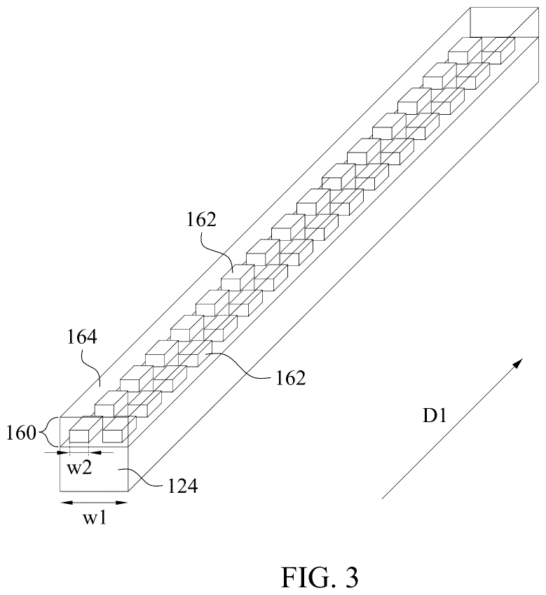

Referring to FIG. 3, the LED display panel 160 includes a plurality of LED components 162. The LED components 162 are disposed on the fringe region 124 of the backlight module 120 and arranged in at least two lines along with an extending direction D1 of the sealant 142 (as shown in FIG.1). The LED components 162 may be organic light emitting diodes (OLEDs), micro LEDs or other LED components.

In the embodiment of FIG. 3, each of the LED components 162 may be a white light LED component. In the embodiment, the width w1 of the fringe region 124 of the backlight module 120 may be between 0.5 mm and 10 mm, while the width w2 of the LED component 162 may be between 3 μm and 500 μm. Thus, the width w1 of the fringe region 124 may be similar to and larger than two widths w2 of the LED component 162. However, the ranges of the width w1 of the fringe region 124 and the width w2 of the LED component 162 are not limited to aforementioned embodiments.

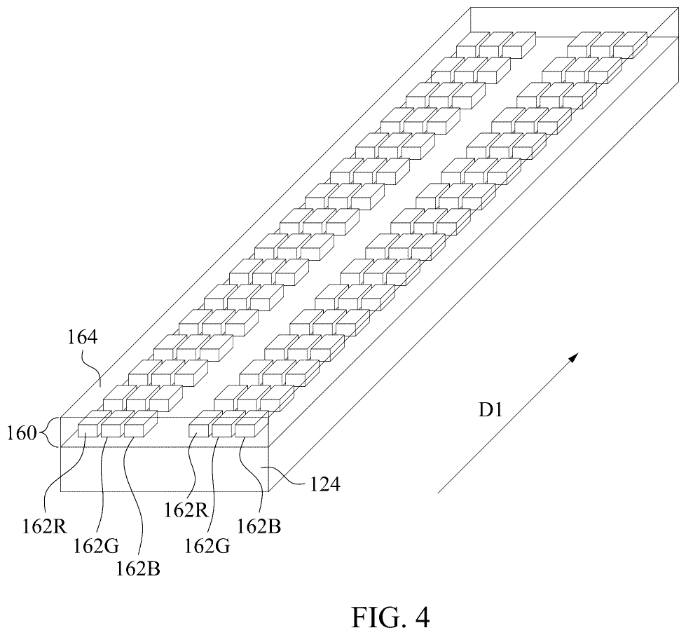

It is worth mentioning that the arrangement of the LED components is not limited to aforementioned embodiment. Referring to FIG. 4, in another embodiment, the LED components may emit a plurality of light rays having different wavelengths. For example, the LED components may be a plurality of red light LED components 162R, a plurality of green light LED components 162G and a plurality of blue light LED components 162B, respectively. The aforementioned LED components in different color are arranged in six lines alternately. Each of the LED components may be seen as a sub-pixel of the LED display panel 160, while one red light LED component 162R, one green light LED component 162G and one blue light LED component 162B which are adjacent to each other one by one may be seen as a pixel of the LED display panel 160.

In other words, the red light LED components 162R, the green light LED components 162G and the blue light LED components 162B are arranged in six lines, respectively, along with the extending direction D1 of the sealant 142 (as shown in FIG. 1). It is worth mentioning that the ranges of the wavelength of the light ray emitted by the LED components in the disclosure are not limited to aforementioned embodiment. (i.e., at least one of the LED components 162 may be a yellow light LED component)

Referring to FIG. 2, the backlight module 120 further incudes at least an optical film 126 disposed on the light exiting region 122, and the optical film 126 is located at one side of the backlight module 120 facing to the LCD panel 140. It is worth mentioning that the optical film 126 extends to the fringe region 124 from the light exiting region 122 of the backlight module 120 and covers the LED display panel 160. As a result, the light ray L1 emitted by the backlight module 120 and the light ray L2 emitted by the LED display panel 160 may pass through the optical film 126, and the difference of the light extraction efficiency (including the light filed and the light uniformity) between the light ray L1 and the light ray L2 may decrease due to the adjustment of the optical film 126.

Specifically, the optical film 126 may include a prism sheet (not shown) and a diffuser sheet (not shown). After being adjusted by the prism sheet, the light field of the light ray L1 and the light ray L2 are approximately the same. In addition, the light ray L1 and the light ray L2 may be diffused by passing through the diffuser sheet so as to improve the light uniformity. As a result, the user's sensitivity to the difference between the exiting light ray L1 and the exiting light ray L2 may be reduced when the user is viewing the display module 100, and thereby improving the continuity of the images.

It is worth mentioning that the optical film 126 is disposed on the LED display panel 160. In order to prevent the LED components 162 from being crushed or damaged by the optical film 126, the LED display panel 160 further includes an encapsulation material 164. The encapsulation material 164 encapsulates the surface of the LED components 162 so as to protect the LED components 162. The encapsulation material 164 may be translucent materials, such as optical clear adhesives or other similar materials.

The LCD panel 140 includes a thin film transistor (TFT) array substrate 143, a light filter substrate 145 and a liquid crystal layer 147. The liquid crystal layer 147 is disposed between the TFT array substrate 143 and the light filter substrate 145. It is worth mentioning that the sealant 142 of the LCD panel 140 is also disposed between the TFT array substrate 143 and the light filter substrate 145 and covers the liquid crystal layer 147 to prevent the liquid crystal polymers within the liquid crystal layer 147 from leaking out. The liquid crystal layer 147 is located above the light exiting region 122 of the backlight module 120, while the sealant 142 is located above the fringe region 124 of the backlight module 120.

The TFT array substrate 143 includes a glass substrate and a TFT array disposed on the glass substrate without being illustrated in figures. In addition, the light filter substrate 145 includes another glass substrate and a filter, such as a color filter, which is disposed on the glass substrate. The TFT array is disposed facing to the filter, that is, the TFT array and the filter are located between these two glass substrates.

The LCD panel 140 further includes a polarizer 144a and a polarizer 144b. The polarizer 144a and the polarizer 144b are located at two opposite sides of the LCD panel 140 separately. In the embodiment, the polarizers (including the polarizer 144a and the polarizer 144b) overlap the LED display panel 160 in the normal direction N1. Thus, a part of the light ray L2 which is emitted by the LED display panel 160 enters the sealant 142 of the LCD panel 140 through the polarizer 144a and then exits the sealant 142 of the LCD panel 140 through the polarizer 144b.

The LCD panel 140 in the embodiment is a normally black LCD panel, where the direction of polarization of the polarizer 144a is perpendicular to the direction of polarization of the polarizer 144b. As a result, when there is no light scattering materials or optical phase retarder, such as a half-wave plate, between the polarizer 144a and the polarizer 144b, the light ray L2 emitted by the LED display panel 160 is blocked by the polarizer 144a and the polarizer 144b, so that the light ray L2 is unable to pass through the sealant 142 of the LCD panel 140.

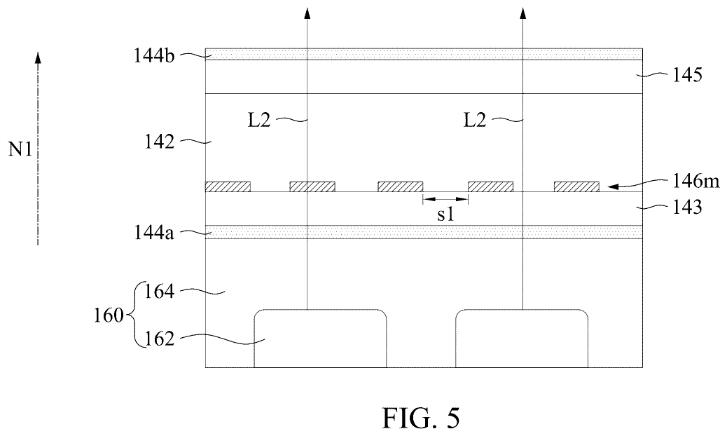

In order to solve the issue that the light ray L2 emitted by the LED display panel 160 is blocked by the polarizer 144a and the polarizer 144b, the LCD panel 140 of at least one embodiment includes a depolarizing structure. Referring to FIG. 5, a depolarizing structure 146m is disposed inside the sealant 142. The depolarizing structure 146m is located between the polarizer 144a and the polarizer 144b, while the depolarizing structure 146m, the polarizer 144a, the polarizer 144b and the LED display panel 160 overlap each other in the normal direction N1. When the light ray (e.g., the light ray L2) passes through the polarizer 144a, and then a polarized light ray with one polarizing direction is formed, the polarizing direction and the polarization state of the polarized light may be changed by the depolarizing structure 146m. Thus, the polarized light ray (or a part of the polarized light ray) may pass through the polarizer 144b.

For example, in the embodiment illustrated in FIG. 5, the depolarizing structure 146m may be a metal wire grid. The metal wire grid (i.e., the depolarizing structure 146m) overlaps the polarizer 144a and the polarizer 144b in the normal direction N1, and the spacing s1 of the metal wire grid is smaller than the wavelength of the light ray L2 emitted by the LED display panel 160, for example, the spacing s1 is smaller than 150 nm. As a result, when the light ray L2 passes through the polarizer 144a, and thus a polarized light is formed, the metal wire grid is able to change the polarizing direction of this polarized light.

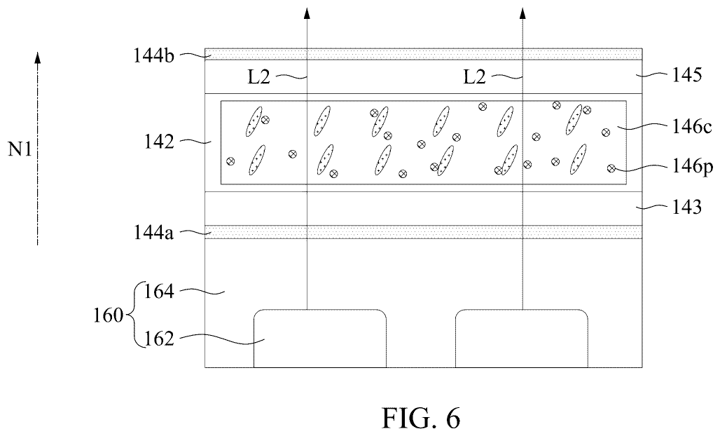

Referring to FIG. 6, in another embodiment, the depolarizing structure may include polymer sustained alignment (PSA) liquid crystal layer 146c. It is worth mentioning that the sealant 142 encapsulates the outside of the PSA liquid crystal layer, and the sealant 142 spaced the PSA liquid crystal layer 146c from the liquid crystal layer 147 (shown in FIG. 2) of the LCD panel 140. The depolarizing structure cures the liquid crystal materials (not denoted) inside the PSA liquid crystal layer 146c by the polymers 146p (e.g., photoinitiators or similar polymer materials) distributed in the PSA liquid crystal layer 146c. Thus, the liquid crystal materials inside the PSA liquid crystal layer 146c are orientated in specific directions so as to change the polarizing direction of the polarized light.

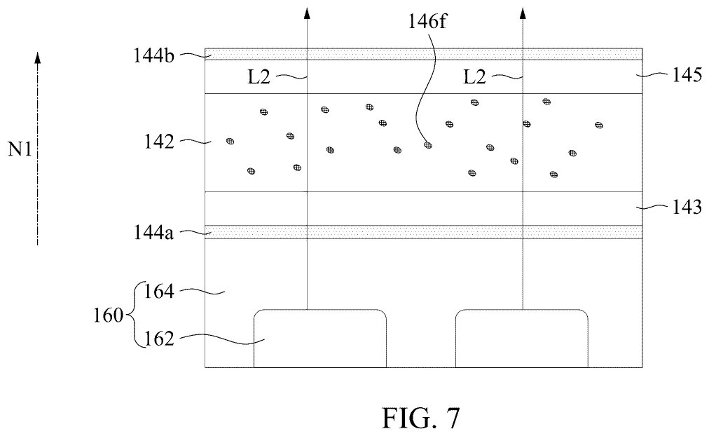

Referring to FIG. 7, in another embodiment, the sealant 142 may include a plurality of scattering particles 146f which are distributed in the sealant 142. When the light ray L2 passes through the polarizer 144a, and thus the polarized light is formed and enters the sealant 142, the scattering particles 146f may destroy the linear polarization of the light ray L2 so as to change the polarization state of a part of the light ray L2. Thus, the light ray L2 is able to pass through the polarizer 144b. The scattering particles 146f may be inorganic particles such as titanium dioxide (TiO₂), polymer particles or similar materials.

In conclusion, a plurality of display modules are connected to each other through the sealants which are surrounded the LCD panels so as to form a large-sized display. Since there is no pixel located at the sealants, the seams between adjacent display modules are formed, so that the images which are assembled by adjacent LCD panels are discontinuous. Thus, the LED display panel is disposed on the fringe region of the backlight module, so that the LED display panel can emit the light ray toward the sealant. As a result, the light ray emitted by the LED display panel can enter the user's eyes through the sealant of the LCD panel. Therefore, the discontinuity of the images due to the seams decreases, and thereby improving the quality of images.

Furthermore, since the light ray emitted by the LED display panel is blocked by the upper and lower polarizers of the LCD panel, the light ray is unable to pass through the sealant. Therefore, the depolarizing structure or scattering particles are disposed inside the sealant in at least one embodiment of the disclosure so as to change the polarizing angles (or polarization state) of the light ray. Thus, most of the light ray can pass through the sealant through the upper and lower polarizers, and then enters the user's eyes.

Although the embodiments of the present disclosure have been disclosed as above in the embodiments, they are not intended to limit the embodiments of the present disclosure. Any person having ordinary skill in the art can make various changes and modifications without departing from the spirit and the scope of the embodiments of the present disclosure. Therefore, the protection scope of the embodiments of the present disclosure should be determined according to the scope of the appended claims.

What is claimed is:

1. A display module, comprising:
a backlight module having a light exiting region and a fringe region adjacent to the light exiting region;
a LCD panel disposed on the backlight module, wherein the LCD panel comprises a sealant; and
a LED display panel disposed on the fringe region of the backlight module, wherein the LED display panel has a surface, and at least a part of the sealant overlaps the LED display panel in a normal direction of the surface;
wherein the backlight module comprises at least an optical film disposed on the light exiting region, and the optical film is located at one side of the backlight module facing to the LCD panel, wherein the optical film extends from the light exiting region to the fringe region of the backlight module and covers the LED display panel.

2. The display module of claim 1, wherein the optical film comprises a prism sheet and a diffuser sheet.

3. The display module of claim 1, wherein the LCD panel comprises:
a TFT array substrate;
a light filter substrate disposed on the TFT array substrate; and
a liquid crystal layer disposed on the light filter substrate, wherein the liquid crystal layer is disposed between the TFT array substrate and the light filter substrate.

4. The display module of claim 3, wherein the sealant of the LCD panel is disposed between the TFT array substrate and the light filter substrate, and the sealant of the LCD panel covers the liquid crystal layer.

5. The display module of claim 4, wherein the liquid crystal layer is located above the light exiting region of the backlight module, and the sealant is located above the fringe region of the backlight module.

6. The display module of claim 1, wherein the LCD panel comprises:
two polarizers disposed on two opposite sides of the LCD panel separately, and the polarizers overlap the LED display panel in the normal direction.

7. The display module of claim 6, wherein the LCD panel is a normally black LCD panel, and the LCD panel comprises:
a depolarizing structure disposed inside the sealant, wherein the depolarizing structure is located between the polarizers, and the depolarizing structure, the polarizers and the LED display panel overlap each other in the normal direction.

8. The display module of claim 7, wherein the depolarizing structure is a metal wire grid, wherein a spacing of the metal wire grid is smaller than a wavelength of a light ray emitted by the LED display panel.

9. The display module of claim 7, wherein the depolarizing structure comprises:
a polymer sustained alignment (PSA) liquid crystal layer, wherein the sealant encapsulates an outside of the PSA liquid crystal layer, and the PSA liquid crystal layer is spaced from a liquid crystal layer of the LCD panel by the sealant.

10. The display module of claim 7, wherein the depolarizing structure comprises:
a plurality of scattering particles distributed inside the sealant.

11. A display module, comprising:
a backlight module having a light exiting region and a fringe region adjacent to the light exiting region;
a LCD panel disposed on the backlight module, wherein the LCD panel comprises a sealant; and
a LED display panel disposed on the fringe region of the backlight module, wherein the LED display panel has a surface, and at least a part of the sealant overlaps the LED display panel in a normal direction of the surface, and the LED display panel comprises:
a plurality of LED components disposed on the fringe region of the backlight module, wherein the plurality of LED components are arranged in at least two lines along with an extending direction of the sealant;
wherein the backlight module comprises at least an optical film disposed on the light exiting region, and the optical film is located at one side of the backlight module facing to the LCD panel, wherein the optical film extends from the light exiting region to the fringe region of the backlight module and covers the LED display panel.

12. The display module of claim 11, wherein the LED display panel comprises:
an encapsulation material encapsulating a surface of the plurality of LED components.

13. The display module of claim 11, wherein a width of the fringe region is larger than two widths of one of the plurality of LED components.

14. The display module of claim 11, wherein each of the plurality of LED components is a white light LED component.

15. The display module of claim 11, wherein the plurality of LED components emit a plurality of light rays having different wavelengths.
